(19) United States
(12) Patent Application Publication
(10) Pub. No.: US 2005/0143107 A1
(43) Pub. Date: Jun. 30, 2005

(54) Method and apparatus for notifying unavailability of broadcast/multicast services

(75) Inventors: Sudhir B. Pattar, Mount Laurel, NJ (US); Rangaprabhu Parthasarathy, Devon, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/000,305

(22) Filed: Nov. 30, 2004

Related U.S. Application Data
(60) Provisional application No. 60/525,966, filed on Dec. 1, 2003.

(51) Int. Cl. H04Q 7/20

(52) U.S. Cl. 455/466

(57) ABSTRACT

A method for notifying a broadcast/multicast control (BMC) entity of service unavailability in a wireless transmit/receive unit (WTRU) is disclosed. When a user activates broadcast/multicast services (BMS), the WTRU receives BMS messages in accordance with the BMS schedule. A radio resources control (RRC) entity constantly monitors whether BMS is available in a cell. If the RRC entity detects the BMS service is not available, the RRC entity sends a message to the BMC entity to inform the unavailability of the BMS.

### CROSS REFERENCE TO RELATED APPLICATION

This application claims the benefit of U.S. Provisional Application No. 60/525,966 filed Dec. 1, 2003, which is incorporated by reference as if fully set forth.

### FIELD OF INVENTION

The present invention is related to a wireless communication system. More particularly, the present invention is related to a method for notifying a broadcast/multicast control (BMC) entity of service unavailability in a wireless transmit/receive unit (WTRU).

### BACKGROUND

Broadcast/multicast control (BMC) is a sub-layer of Layer 2 (L2) in a user-plane of the universal mobile telecommunication system (UMTS) protocol stack. The BMC provides services necessary to deliver and receive cell broadcast messages. A user subscribes to certain types of broadcast or multicast services and selectively receives particular broadcast or multicast messages in accordance with a broadcast/multicast service (BMS) schedule.

As a WTRU moves across the boundary of a cell, the WTRU performs a cell selection and reselection process. During the cell selection and reselection process, the WTRU may enter an area where cell broadcast services (CBS) are not available or disrupted. Currently, there is no mechanism for the user to know that the CBS is currently not available.

In addition, due to a cell change, the discontinuous reception (DRX) schedule for the common traffic channel (CTCH) that was configured in the previous cell becomes invalid in the current cell. At this stage, the UMTS physical layer (PHY) has to be reconfigured in the new cell with a new DRX schedule by the BMC via radio resource control (RRC). Currently, there is no mechanism for BMC to know that the currently configured DRX schedule is invalid due to cell reselection. Until a valid new schedule is received, the PHY is unable to receive the BMS properly.

FIG. 1 is a signal flow diagram of a BMC process 100 in accordance with a prior art WTRU 150, including non-access stratum (NAS), radio resource control (RRC), BMC, radio link control (RLC) and PHY entity. When a user activates BMS, an activation request is sent from the NAS to the BMC (step 102), which provides services to the NAS. If it is the first time the user activates the BMS, the BMC indicates to the RRC by transmitting a Start_CB message that cell broadcast (CB) message reception should be started (step 104). The RRC receives system information and configures the PHY in accordance with the CB configuration (step 106). The PHY receives all BMS messages over radio interface, (not shown), including a BMS schedule message (step 108) and forwards the BMS messages to the RLC, which in turn forwards them to the BMC (step 110).

The BMS schedule message informs which CB messages will be sent in the next DRX schedule. The BMC retrieves the schedule for BMS for the user and transmits the Start_DRX message to the RRC to indicate the BMC messages that should be received by the WTRU (step 112). The RRC then configures the PHY at which time intervals the PHY should receive messages (step 114). As a consequence, only the CB messages of interest are received by the PHY and delivered to the BMC and to the user (steps 116, 118, 120).

When a user moves across the cell, a cell reselection procedure is initiated (step 122). If CBS is not supported or disrupted in the new cell, the user is not able to receive BMS properly. The user does not have any information regarding the non-availability of CBS in the new cell. Even if the new cell supports the CBS and a new common traffic channel (CTCH) is acquired, the PHY does not have the DRX schedule required to select appropriate CB messages. The BMC does not have any way to know that cell reselection has occurred. The PHY is not able to pick up any relevant block sets due to a lack of an updated and appropriate DRX schedule. If the PHY continues to apply the DRX schedule of the old cell in the new cell, then due to the possibility of missing the reception of the schedule message, the BMC may never synchronize to receive the relevant messages.

### SUMMARY

The present invention is related to a method for notifying a BMC of service unavailability. When a user (i.e. a WTRU) activates BMS, the WTRU receives BMS messages in accordance with a BMS schedule message. An RRC constantly monitors whether BMS is available in a cell. If the RRC detects that the BMS service is not available, the RRC sends a message to the BMC to inform the BMC of the unavailability of the BMS.

In accordance with the present invention, BMC operations are more predictable, robust and dependable. The WTRU can be provided with timely indication of CBS unavailability. The potential deadlock situation that could occur between the PHY not receiving updated DRX schedules after cell reselection and the BMC not knowing that such cell reselection has occurred can be avoided and normal operations can occur smoothly without any confusion. The present invention may be applied to different wireless communication systems, such as UMTS and GSM.

### BRIEF DESCRIPTION OF THE DRAWINGS

FIG. 1 is a signal flow diagram of BMS operation in accordance with the prior art.

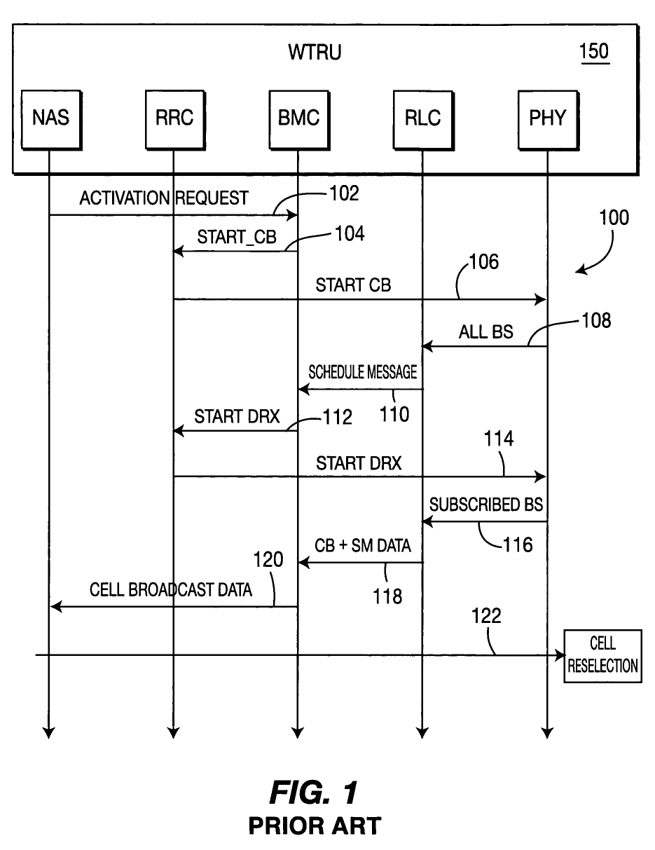

FIG. 2 is a signal flow diagram of BMS operation between entities comprising a WTRU in accordance with the present invention.

### DETAILED DESCRIPTION OF THE PREFERRED EMBODIMENTS

Hereafter, the terminology “WTRU” includes but is not limited to a user equipment, a mobile station, a fixed or mobile subscriber unit, a pager, or any other type of device capable of operating in a wireless environment. When referred to hereafter, the terminology “base station” includes but is not limited to a Node-B, a site controller, an access point or any other type of interfacing device in a wireless environment.

The present invention provides a mechanism for the BMC to be notified of cell reselection, service unavailability, service resumption, and reconfiguration of the PHY with a new DRX schedule after cell reselection. The present invention also provides a mechanism to inform the NAS of service disruption and resumption.

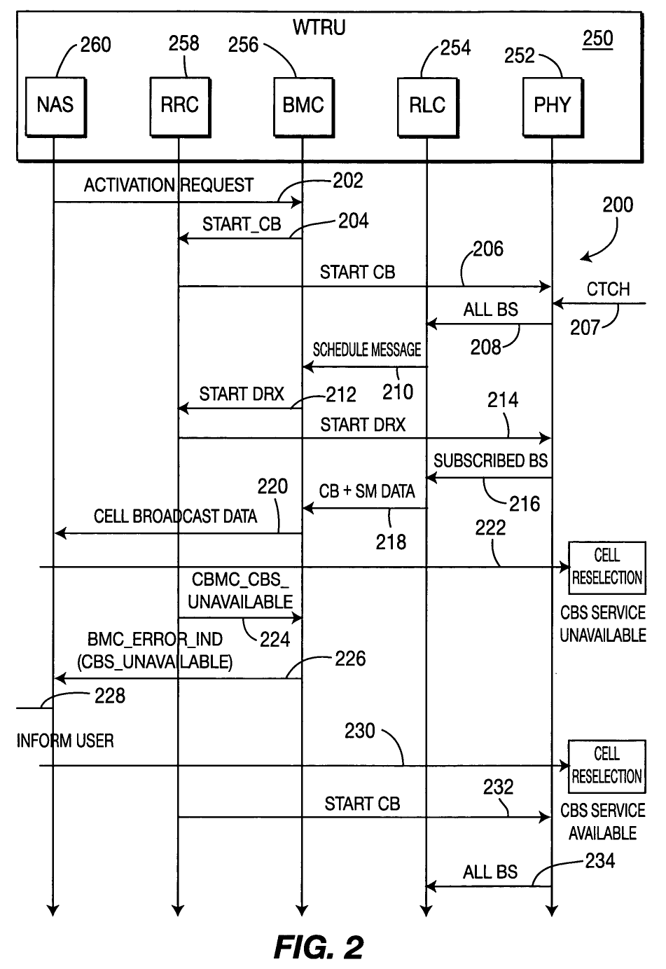

FIG. 2 is a signal flow diagram of a BMS process 200 between entities in a WTRU 250 in accordance with one embodiment of the present invention. The WTRU 250 comprises a PHY 252, an RLC 254, a BMC 256, an RRC 258, and an NAS 260. Although these entities are well known to those of skilled in the art, the following provides a brief overview of the function of each entity. The PHY 252 interfaces with the hardware and radio transmitter and receiver of the WRTU 250 to configure, receive and transmit data.

The RLC 254 provides the link layer functionality by supporting transparent, unacknowledged and acknowledged data transfer. The RLC 254 interfaces with the media access control (MAC) protocol layer, which interfaces with the PHY 252 to provide transport channels for data transport to the RLC 254.

The BMC 256 is the control entity governing the reception of broadcast and multicast messages. It keeps track of the message identifiers of the BMC messages that the user is interested in receiving; or has subscribed to receive. It also generates a DRX schedule to configure the PHY 252 to receive only certain CTCH block sets which contain the messages in which the user is interested. Thus, by employing discontinuous reception, the BMC 256 helps in power conservation.

The RRC 258 is the radio resource control protocol layer, which manages the radio resources and configures other layers. It also performs measurements and receives the system information and paging information.

The NAS 260 is the non-access stratum, which keeps track of the mobility and session management. It also configures the BMC 256 and interfaces with the BMC 256 to receive the broadcast messages.

The interplay between all of the elements 252-260 of the WTRU 250 will be explained hereinafter with reference to the signal flow diagram of FIG. 2 for the BMS process 200. When a user activates BMS, an activation request is sent from the NAS 260 to the BMC 256 (step 202). If it is the first time the user activates the BMS, the BMC 256 indicates to the RRC 258 by transmitting a Start_CB message that cell broadcast (CB) message reception should be started (step 204). The RRC 258 configures the PHY 252 in accordance with the CB configuration (step 206). The PHY 252 receives all BMS messages, including a BMC schedule message from a base station via a CTCH (step 207) in accordance with the configuration specified by the RRC 258, and forwards all the CTCH block sets containing the BMC messages to the RLC 254 (step 208), which in turn forwards them to the BMC 256 (step 210).

The BMC schedule message informs the BMC 256 which CB messages will be sent when in the next DRX schedule. The BMC 256 retrieves the schedule for BMS for the user and transmits a Start_DRX message to the RRC 258 to indicate the BMS messages that should be received by the WTRU 250 by providing a set of CTCH block set indexes (step 212). The RRC 258 then configures the PHY 252 at which time intervals the PHY 252 should receive messages (step 214). As a consequence, only the CB messages of interest are received by the PHY 252 and delivered to the BMC 256 and to the user as will be explained hereinafter.

After the PHY 252 receives the DRX schedule, the PHY 252 selectively receives the CTCH block sets by turning on the receiver only for the scheduled block sets and forwards them to the RLC 254 as indicated in step 216. The RLC 254 then forwards the received information to the BMC 256 (step 218). If the received message contains a cell broadcast message (CBS), the BMC 256 then forwards the message to the NAS 260 (step 220). If the received message contains a schedule message then the BMC 256 generates a schedule message for the next schedule period and sends a Start_DRX message to the RRC 258 (step 212).

When a user moves across the cell, a cell reselection procedure is initiated (step 222). The RRC 258 constantly monitors messages broadcast from nearby cells, for example, via a broadcast control channel (BCCH). The RRC 258 monitors the BCCH of the cell to receive the system information. The system information Type 5 and 6 contains the information indicating the availability of CTCH and CBS related information in the current cell. System information Type 5 message contains a Boolean value indicating the availability of CTCH in the current cell and contains CBS related information if CTCH is available in the cell. If the RRC 258 fails to receive any messages from the new cell via the BCCH, the RRC 258 recognizes that CBS is not available in the new cell.

The present invention introduces a new signal, (CBMC_CBS_UNAVAILABLE), from the RRC 258 to the BMC 256 to indicate the unavailability or disruption of CBS. If the RRC 258 detects the unavailability of the BMS, the RRC 258 transmits a message CBMC_CBS_UNAVAILABLE to the BMC 256 to inform the BMC 256 of the disruption or unavailability of BMS (step 224). Other notifications may optionally be transmitted from the RRC 258 to the BMC 256 that could be conveyed to the NAS 260 including, but not limited to, the addition of enumerations or cause types to the existing signals. The disruption or unavailability of CBS service can be indicated by including a cause type in the CBMS_CBS_UNAVAILABLE message or by sending a separate message carrying the cause type. The disruption or unavailability can be due to many reasons, such as, but not limited to, the network not supporting it in current cell, the reception of CTCH being very poor, the WRTU not having enough resources, such as processing bandwidth or memory to currently handle CBS. Each of these causes can be enumerated and the enumeration identifier can be used to convey the cause of disruption.

Once the BMC 256 is notified of the unavailability of BMS, the BMC 256 sends a message to the NAS 260 to inform the NAS 260 of the unavailability of BMS (step 226). The BMC 256 sends a BMC_ERROR_IND to indicate the existence of an error to the NAS 260. The BMC 256 preferably includes a cause of the error, (CBS_UNAVAILABLE), in the BMC_ERROR_IND to indicate a disruption or unavailability of BMS as noted hereinbefore.

In an alternative embodiment, the RRC 258 may directly inform the NAS 260 of the disruption of BMS, however, it is preferable for the BMC 256 to inform the NAS 260 since the BMC 256 has an existing interface (BMC_ERROR_IND) defined to convey error information to the NAS 260. The NAS 260, in turn, notifies the user of the unavailability of BMS (step 228).

The BMC 256 can utilize the information of service unavailability to reset to a state from where it can commence generation of the new DRX schedule on reception of a schedule message when BMS resumes. It can release the resources (processing and memory) and stop verification of the received messages with the configured DRX schedule to enter a dormant state till the BMS is available again to increase efficiency and reduce battery power consumption.

As the WTRU 250 further moves to another cell, another cell reselection procedure is initiated (step 230). If the RRC 258 detects that BMS is available in the new cell, the RRC 258 retrieves system information and configures the PHY 252 in accordance with the CB configuration (step 232). Alternatively, it can convey the availability of the service to the BMC 256 which can wake up from its dormant state and send a Start_CB message to the RRC 258 to configure the PHY 252 to resume CTCH reception. The PHY 252 receives all BMS messages, including a BMC schedule message, and forwards the BMS schedule message to the RLC 254 (step 234), and normal operation for BMS is resumed.

The current mechanism for starting reception of cell broadcast messages by the PHY 252 is by the RRC 258 instructing the PHY 252 when the RRC 258 receives a CBMC_RX_IND from the BMC 256 with START_CB. CBMC_RX_IND is an interface primitive defined in the 3GPP specifications for the BMC 256-RRC 258 interface. CBMC_RX_IND contains the instruction for the RRC 258 to initiate CB reception (Start_CB), to stop CB reception (Stop_CB), to initiate discontinuous reception (Start_DRX), or to stop discontinuous reception (Stop_DRX).

The RRC 258 forwards these instructions to the PHY 252 to act upon. CBMC_RX_IND may also contain the DRX schedule when Start_DRX instruction is issued. The PHY 252 applies the DRX schedule and receives only the indicated CTCH block sets. In a single cell scenario, (i.e., when the WRTU does not change a cell), the RRC 258 configures the PHY 252 to begin receiving all the CTCH block sets on reception of the Start_CB message from the BMC 256. When the BMC 256 is ready with a DRX schedule for the next scheduling period, it sends the DRX schedule, indicating the CTCH block sets to be received, in CBMC_RX_IND primitive with Start_DRX to the RRC 258. The RRC 258 forwards this to the PHY 252 to act upon.

When the BMC 256 derives a new DRX schedule, it sends it again in the CBMC_RX_IND to the RRC 258. If a user alters a subscription or a misalignment of actually received and configured CTCH block sets is observed, the BMC 256 may send CBMC_RX_IND with Stop_DRX to the RRC 258. The RRC 258 forwards it to the PHY 252 which begins receiving and forwarding all the CTCH block sets. To terminate cell broadcast reception, the BMC 256 can send CBMC_RX_IND to the RRC 258 with Stop_CB. When the WRTU changes a cell, the BMC 256 is not informed of the cell reselection and hence the problems of deadlock may occur.

In accordance with the present invention, as the BMC 256 has no knowledge of cell reselection, the RRC 258 maintains the state of BMS reception, (START_CB/STOP_CB sent by the BMC 256), and configures the PHY 252 with the same state after cell reselection. The state of CBS reception is configured by the BMC 256 by CBMC_RX_IND message with START_CB or STOP_CB as its parameters.

The RRC 258 maintains the last known CBS reception state until the WTRU 250 moves into a new cell where CBS is available. The RRC 258 recognizes the availability of CBS, and sends the CBS state information, START_CB or STOP_CB to the PHY 252 after cell reselection. The physical layer starts picking up all the block sets and forwarding them to the RLC 254, which sends it to the BMC 256. The BMC 256, in turn, picks up the next schedule message, rebuilds the DRX selection list and passes it to the PHY 252 via the RRC 258. This restores the normal BMC operation.

Although the features and elements of the present invention are described in the preferred embodiments in particular combinations, each feature or element can be used alone without the other features and elements of the preferred embodiments or in various combinations with or without other features and elements of the present invention.

1. A method for notifying a broadcast/multicast control (BMC) entity of service unavailability in a wireless transmit/receive unit (WTRU), the method comprising:
activating broadcast/multicast services (BMS) in a WTRU;
monitoring BMS availability in a cell; and
indicating a BMC entity about a non-availability of the BMS when unavailability of BMS is detected.

2. The method of claim 1 further comprising a step of notifying a user of the unavailability of the BMS.

3. The method of claim 2 wherein the BMC entity notifies the unavailability of the BMS to a non-access stratum (NAS), and the NAS in turn notifies the user of the unavailability of the BMS.

4. The method of claim 3 wherein the BMC entity sends BMC_ERROR_IND to indicate the unavailability of the BMS to the NAS.

5. The method of claim 2 wherein a radio resource control (RRC) entity notifies the NAS of the unavailability of the BMS.

6. The method of claim 1 further comprising:
constantly monitoring availability of the BMS after the indication of the unavailability of the BMS;
retrieving system information necessary for discontinuous reception (DRX) of BMS messages when BMS is available; and
resuming BMS operation using the system information.

7. The method of claim 6 wherein the WTRU retrieves system information necessary for DRX of BMS messages after the WTRU fell into a dead lock situation where the WTRU fails to obtain necessary system information for DRX, whereby the WTRU resynchronizes to a new DRX schedule.

8. The method of claim 1 wherein the indication of non-availability of the BMS includes a cause type.

9. The method of claim 1 further comprising a step of entering into a dormant state when it is indicated that BMS is not available until the BMS becomes available again.

10. A wireless transmit/receive unit (WTRU) comprising:
a physical layer entity for receiving messages;
a radio link control (RLC) entity for controlling sequence of delivery of the messages;
a broadcast/multicast control (BMC) entity for controlling broadcast/multicast services (BMS); and
a radio resource control (RRC) entity for controlling configuration of the physical layer entity, the RLC entity and the BMC entity, the RRC entity being configured to notify the BMC entity of unavailability of BMS.

11. The WTRU of claim 10 wherein the BMC entity notifies a user of the unavailability of the BMS.

12. The WTRU of claim 11 wherein the BMC entity notifies the unavailability of the BMS to a non-access stratum (NAS), and the NAS in turn notifies the user of the unavailability of the BMS.

13. The WTRU of claim 12 wherein the BMC entity sends BMC_ERROR_IND to indicate the unavailability of the BMS to the NAS.

14. The WTRU of claim 10 wherein the RRC entity notifies a user of the unavailability of the BMS.

15. The WTRU of claim 10 wherein the indication of non-availability of the BMS includes a cause type.

16. The WTRU of claim 10 further comprising a step of entering into a dormant state when it is indicated that BMS is not available until the BMS becomes available again.
